(19) United States
(12) Patent Application Publication
(10) Pub. No.: US 2013/0085429 A1
(43) Pub. Date: Apr. 4, 2013

(54) CONTROLLER MOUNTABLE ON A COMPRESSION GARMENT

(71) Applicant: Daniel J. Nelsen, Central Falls, RI (US)

(72) Inventor: Daniel J. Nelsen, Central Falls, RI (US)

(73) Assignee: Tyco Healthcare Group LP, Mansfield, MA (US)

(21) Appl. No.: 13/249,436

(22) Filed: Sep. 30, 2011

(51) Int. Cl. A61H 9/00; B23P 17/04

(52) U.S. Cl. 601/149; 29/428

(57) ABSTRACT

A compression garment assembly for applying compression therapy to a body part of a person. The compression garment assembly includes a compression garment, a controller, and a strap for mounting the controller on the compression garment. The controller includes structure configured for cooperating with the strap for mounting the controller on the compression garment. In one embodiment, the structure includes a mounting surface and first and second retainers on opposite sides of the mounting surface. A segment of the strap is receivable in an opening on the controller for mounting the controller on the compression garment.

### FIELD OF THE INVENTION

The present invention is directed generally to a compression garment assembly for applying compression therapy to a body part of a wearer, and more particularly to a controller which is mountable on a compression garment.

### BACKGROUND OF THE INVENTION

Active compression garments for applying intermittent compression therapy to a body part (e.g., a limb such as a leg) have many applications, including DVT prophylaxis, edema prevention, and wound healing. Generally immobile persons are at risk for developing medical conditions that form blood clots, such as deep vein thrombosis (DVT) and peripheral edema. Such persons include those undergoing surgery, anesthesia, and extended periods of bed rest. These blood clotting conditions generally occur in the deep veins of the lower extremities and/or pelvis. These veins, such as the iliac, femoral, popliteal, and tibial veins, return deoxygenated blood to the heart. When blood circulation in these veins is retarded due to illness, injury, or inactivity, there is a tendency for blood to accumulate or pool. A static pool of blood may lead to a blood clot, which can interfere with cardiovascular circulation. More seriously, the blood clot can break loose and migrate. A pulmonary embolus, which may be life threatening, can form if the blood clot blocks a pulmonary artery.

Conventional vascular compression systems include a compression garment fluidly connected to a controller that cyclically inflates the compression garment. The cyclical inflation of the compression garment enhances blood circulation and decreases the likelihood of DVT. A system of conduits connects the compression garment to the controller.

Vascular compression garments having portable controllers have been proposed. These controllers are much smaller and mountable on the compression garment allowing the patient to move more freely without entangling conduits attaching the compression garment to a remote compressor or other compressed air source. These newer compression garments may be worn when a patient is stationary or ambulatory and are believed to enhance patient compliance due to convenience of use.

### SUMMARY OF THE INVENTION

In one aspect, the present invention includes a portable controller configured for use with a flexible elongate strap to releasably mount the controller on a compression garment for providing compression therapy to a body part of a wearer. The strap may be generally elongate, having opposite inner and outer faces extending longitudinally between a first end and a second end opposite the first end and laterally between a first side and a second side opposite the first side. The controller includes a housing sized and shaped for holding components for controlling inflation and deflation of the compression garment. The housing includes a strap mounting surface having a centerline separating a first boundary edge and a second boundary edge. The first and second boundary edges are spaced for receiving therebetween one of the inner and outer faces of the strap so a central longitudinal axis of the strap extends generally parallel to the centerline of the mounting surface of the housing. A first retainer extends from the housing on a first side of the mounting surface centerline to a free end positioned with respect to the mounting surface to overlap the first side of the strap when the respective face of the strap engages the mounting surface and the central longitudinal axis of the strap extends generally parallel to the centerline of the mounting surface. A second retainer extends from the housing on a second side of the mounting surface centerline opposite the first side of the mounting surface centerline to a free end positioned with respect to the mounting surface to overlap the second side of the strap when the respective face of the strap engages the mounting surface and the central longitudinal axis of the strap extends generally parallel to the centerline of the mounting surface.

In another aspect, the present invention includes a method of mounting a portable controller housing on a compression garment using a strap. The method includes positioning the controller between an outer surface of the compression garment and an inner face of the strap. The method also includes inserting a segment of the strap in an opening of the controller housing so the inner face of the strap engages the housing.

Other features will be in part apparent and in part pointed out hereinafter.

### BRIEF DESCRIPTION OF THE DRAWINGS

FIG. 1 is a schematic, fragmentary elevation of a compression garment assembly of the present invention including a compression garment, only a portion of which is shown, a controller, and a strap for mounting the controller on the compression garment;

FIG. 2 is a schematic top view of the compression garment assembly as applied to a leg;

FIG. 3 is a schematic elevation of the compression garment and strap, the compression garment being shown in an open, unwrapped configuration;

FIG. 4 is an enlarged schematic fragmentary elevation of the compression garment showing details of the strap;

FIG. 5 is a schematic front elevation of the controller;

FIG. 6 is a schematic right side elevation of the controller;

FIG. 7 is a schematic, fragmentary elevation of a compression garment assembly of a second embodiment of the present invention, only a portion of the compression garment being shown;

FIG. 8 is a schematic, fragmentary side elevation of a compression garment assembly of a third embodiment of the present invention, only a portion of the compression garment being shown; and

FIG. 9 is a schematic rear elevation of a strap of a fourth embodiment of the present invention.

Corresponding reference characters indicate corresponding parts throughout the drawings.

### DETAILED DESCRIPTION OF THE DRAWINGS

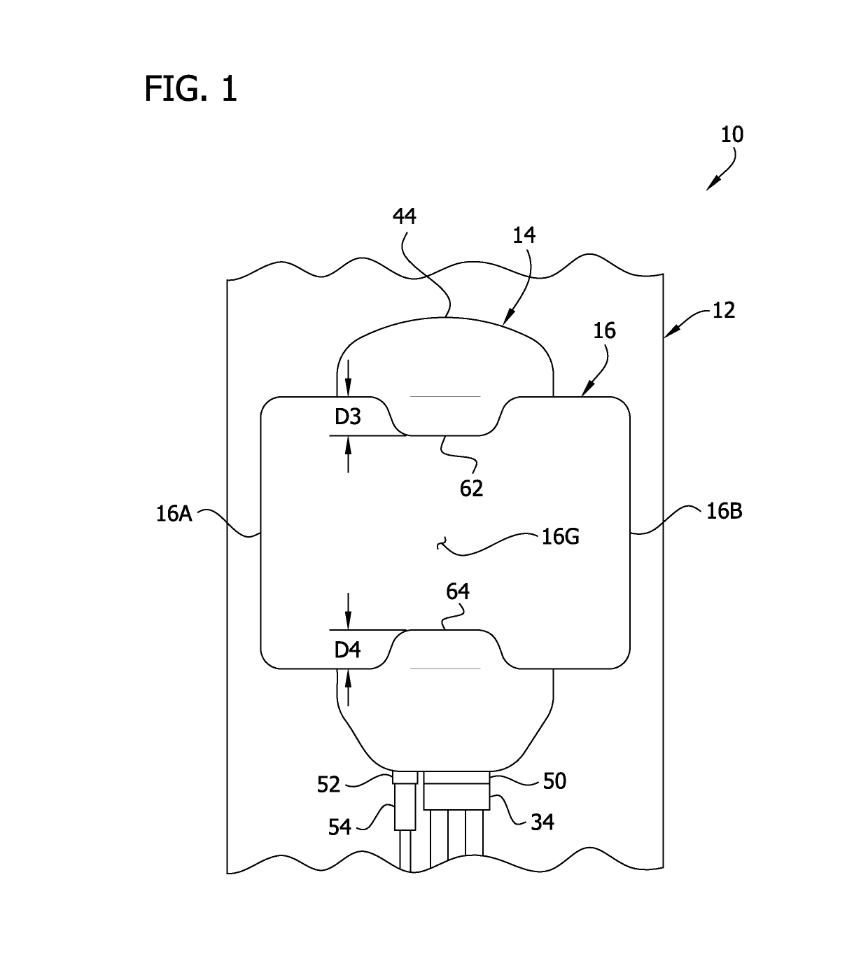

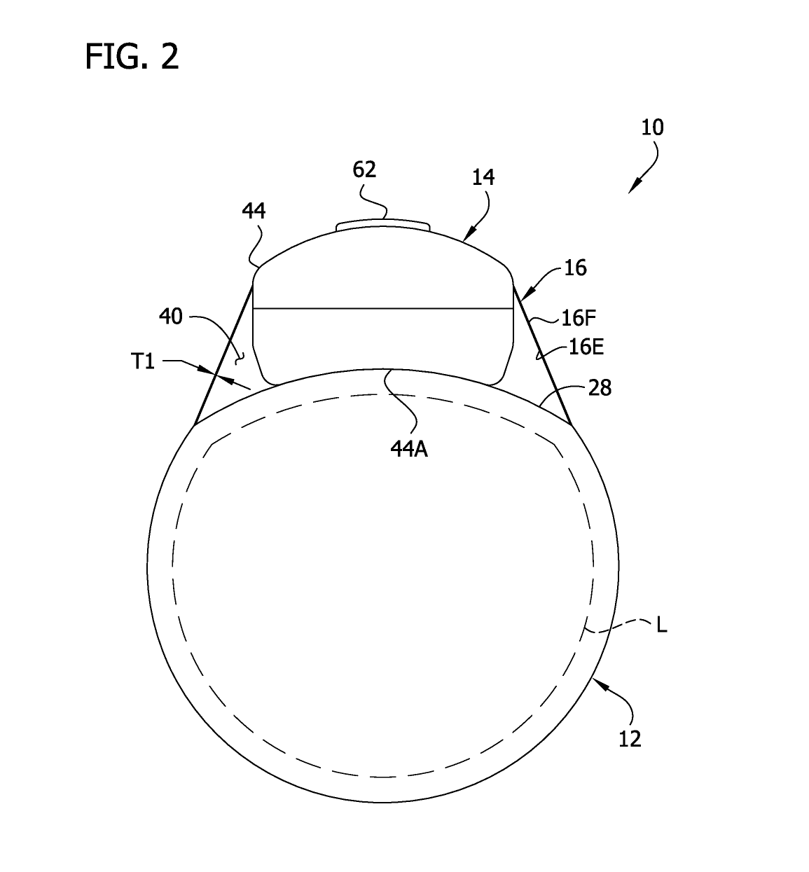

Referring to FIG. 1, one embodiment of a compression assembly of the present invention is generally indicated by the reference number 10. The compression garment assembly 10 is wearable on a body part of a person (e.g., a limb such as a leg or arm) for providing compression therapy to the body part. The compression garment assembly 10 is shown on a limb L in FIG. 2. The compression garment assembly 10 includes a compression garment (only a portion being shown in FIG. 1), generally indicated by the reference number 12, and a portable controller, generally indicated by the reference number 14. As explained in further detail below, the controller 14 supplies pressurized fluid to the compression garment 12 for compressing the body part. As also explained in further detail below, the controller 14 is releasably mountable on the compression garment 12 using a strap, generally indicated by the reference number 16. The controller includes structure configured for cooperating with the strap 16 for mounting the controller on the compression garment. The compression garment 12 may be disposable (e.g., single-use, or multiple use with a single patient), and the controller 14 may be used with multiple compression garments.

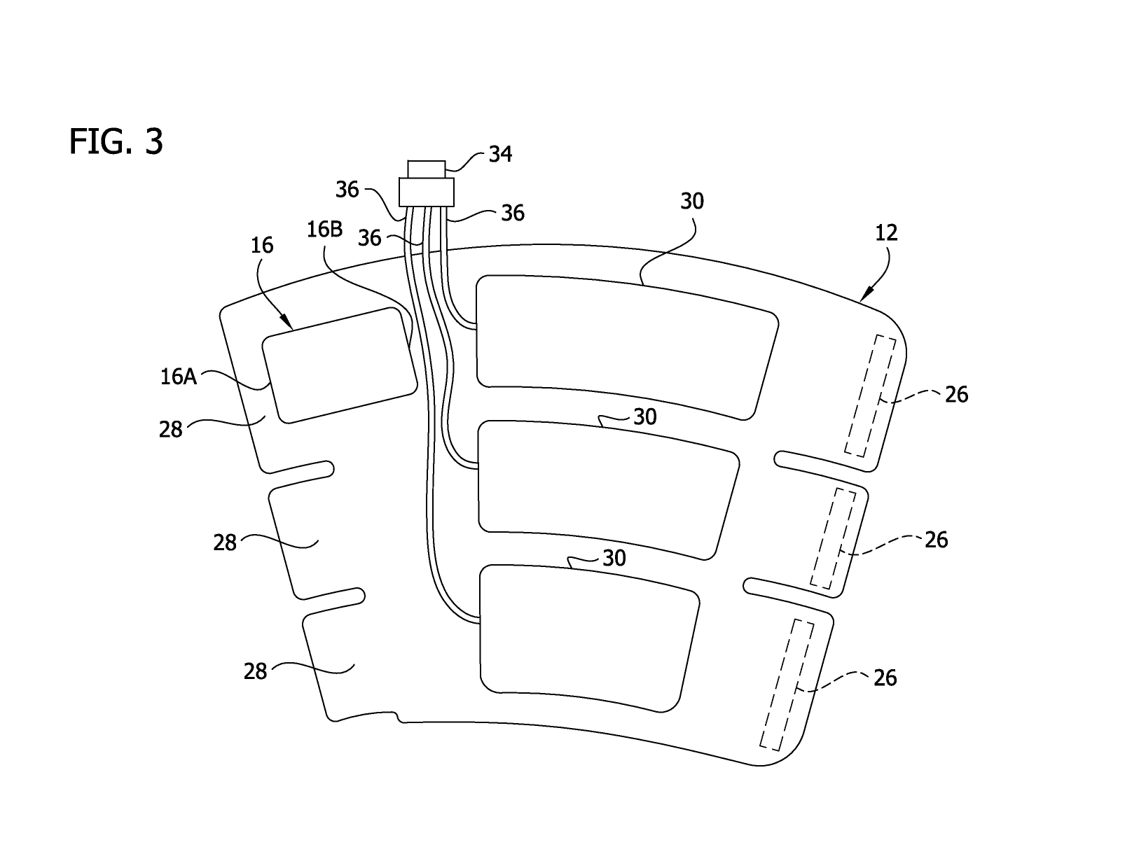

An exemplary compression garment 12 is shown in further detail in FIG. 3. The illustrated compression garment 12 is configured to be applied to a leg and has a “knee length” size, meaning the compression garment extends generally from the ankle to the knee. Garments having other sizes and shapes (e.g., for other body parts) may be used without departing from the scope of the present invention. The compression garment 12 is adapted to be wrapped around the body part in a closed, wrapped (self-retaining) configuration. Fasteners 26 are provided on the compression garment for securing the compression garment 12 in the self-retaining configuration on the body part. For example, the fasteners 26 may be hook fabric which is formed for releasable connection with loop fabric on an outer surface 28 of the compression garment 12 (e.g., loop fabric laminated to the outer surface of the compression garment). As used herein, the words “inner” and “outer” refer to orientations with respect to the body part on which the compression garment assembly 10 is worn.

The compression garment 12 includes three spaced apart inflatable bladders 30 capable of retaining pressurized air for compressing the body part. The garment 10 has a fluidic connector 34 for releasably connecting the garment in fluid communication with the controller 14. Fluid is delivered from the connector 34 to the bladders 30 via tubing 36. The garment 12 may be constructed using various layers, such as laminated layers including internal layers of PVC for forming the bladders 30. Various materials and methods for constructing compression garments of this type are known in the art and are not discussed in further detail herein.

Garments configured other than described herein may be used without departing from the scope of the present invention. For example, garments having other sizes (e.g., “thigh length,” extending generally from the ankle to the thigh), other shapes (e.g., tubular for sliding onto a body part), other numbers of bladders, and other fasteners may be used without departing from the scope of the present invention.

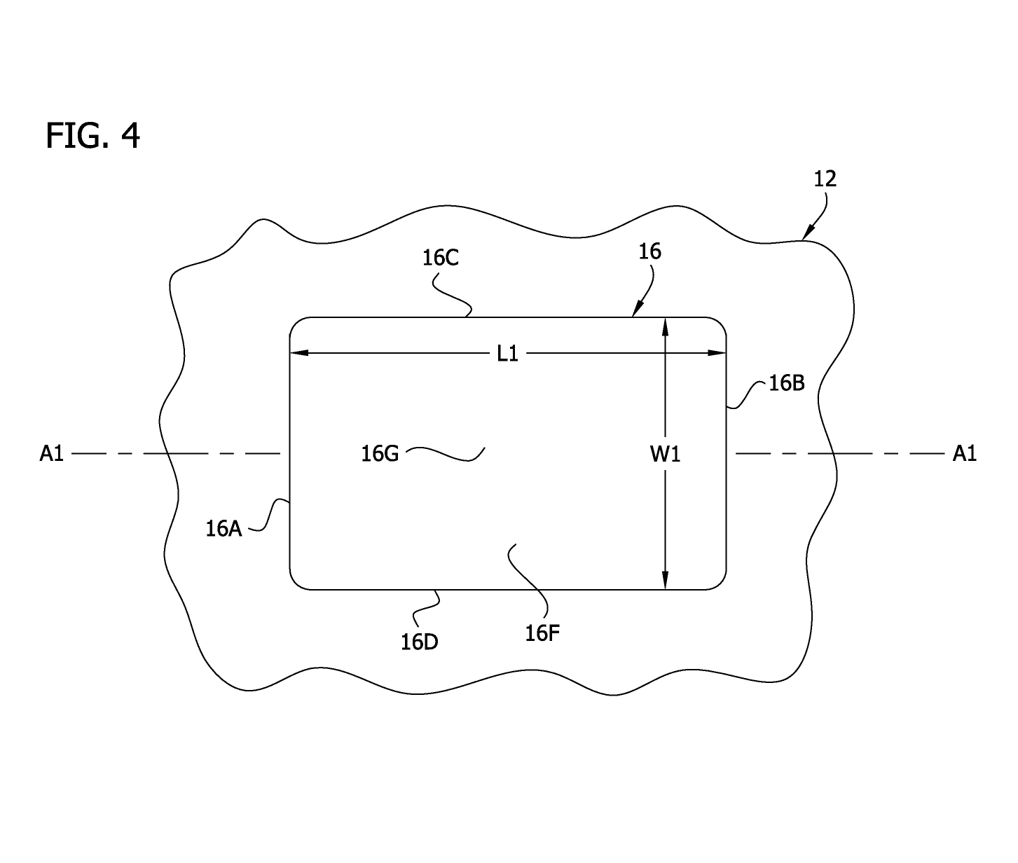

The strap 16 for mounting the controller 14 on the compression garment 12 is shown in FIGS. 1-4. As shown in FIG. 2, when the controller 14 is mounted on the compression garment 12, the controller is positioned between the outer surface 28 of the compression garment 12 and the strap 16. An enlarged view of the strap 16 is provided in FIG. 4. The strap 16 may have a generally rectangular shape with opposite first and second ends 16A, 16B and opposite sides 16C, 16D extending between the ends. The strap has a length L1 between the ends 16A, 16B and a width W1 between the sides 16C, 16D. The strap 16 includes a central longitudinal axis A1. Moreover, the strap 16 includes opposite inner and outer major faces 16E, 16F (FIG. 2). The inner and outer faces 16E, 16F extend longitudinally between the first and second ends 16A, 16B and laterally between the first and second sides 16C, 16D. The strap 16 has a thickness T1, as shown in FIG. 2.

The strap 16 may be made of material such as woven or non-woven cloth or fabric. Desirably, the strap 16 is flexible, but in some embodiments the strap may be semi-rigid or rigid. In the illustrated embodiment, the strap 16 is substantially inextensible, but the strap may be semi-extensible or extensible.

In the illustrated embodiment, the strap 16 is shown as being formed separately from the compression garment 12, and the ends of the strap 16A, 16B are both attached to the compression garment. More specifically, the ends 16A, 16B may be fixed to the compression garment 12 such as by stitching, fusing, adhering, or another suitable method. Alternatively, the strap 16 may be formed as part of the compression garment 12 so the ends 16A, 16B are unitary with material of the compression garment. For example, an outer layer of the compression garment 12 may be formed to define the strap 16. Moreover, in other embodiments, such as embodiments described below, the strap may be releasably or selectively attachable to the compression garment 12 and/or the strap may be attachable to itself (e.g., when wrapped around the compression garment) for mounting the controller 14 on the compression garment.

The strap sides 16C, 16D and an intermediate segment 16G of the strap 16 between the strap ends 16A, 16B are generally free from connection to the compression garment 12 to provide a space 40 (FIG. 2) between the strap and the outer surface 28 of the compression garment 12 suitable for receiving the controller 14. As shown in FIG. 2, the controller 14 occupies at least part of the space 40 when the controller is mounted on the compression garment 12. In this position, the controller 14 engages the inner face 16E of the strap and the outer surface 28 of the compression garment 12. The controller 14 includes a housing 44 which may have a contoured inner surface 44A to correspond to a preselected portion of the body part. In the illustrated embodiment, the inner surface 44A is curved to corresponding to curvature of a leg.

The controller 14 supplies pressurized fluid (e.g., air) to the compression garment 12 for inflating the bladders 30 on the compression garment for compressing the leg. As shown in FIG. 1, the controller 14 includes a port 50 adapted for receiving the fluidic connector 34 of the compression garment 12. The controller housing 44 is sized and shaped for housing various components for controlling inflation and deflation of the bladders 30 on the compression garment 12. For example, the housing 44 may house control components such as a processor, memory, and valving, and house a source of pressurized fluid such as a pump and/or reservoir (not shown). The controller 14 may also include a battery (not shown) and a charging port 52 which is shown connected to a power source cord 54 in FIG. 1. Persons having ordinary skill in the art are familiar with components such as these used in controllers for compression garments. Thus, the components are not described in further detail. Persons having ordinary skill in the art also understand the controller 14 may control pressurization of the bladders 30 in various ways. For example, the controller 14 may inflate the bladders 30 intermittently and sequentially (e.g., from the ankle to the knee). Controllers having other configurations and inflation routines may be used without departing from the scope of the present invention.

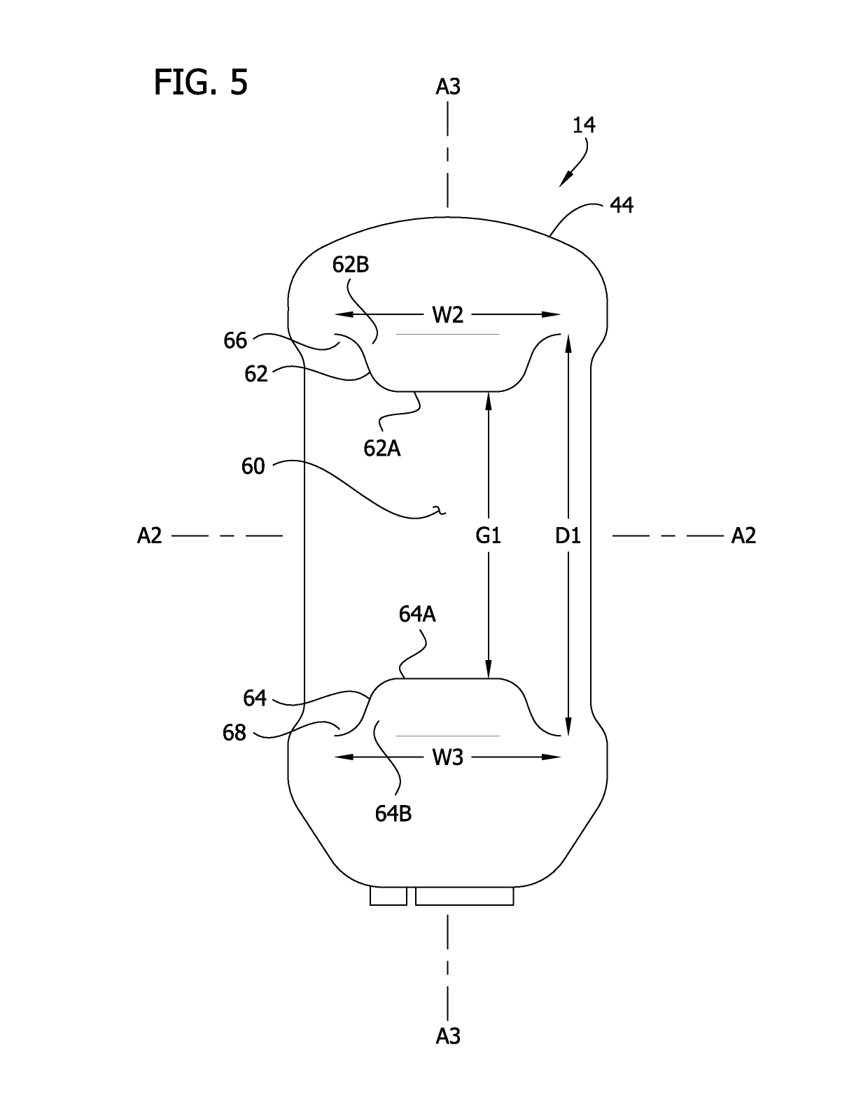

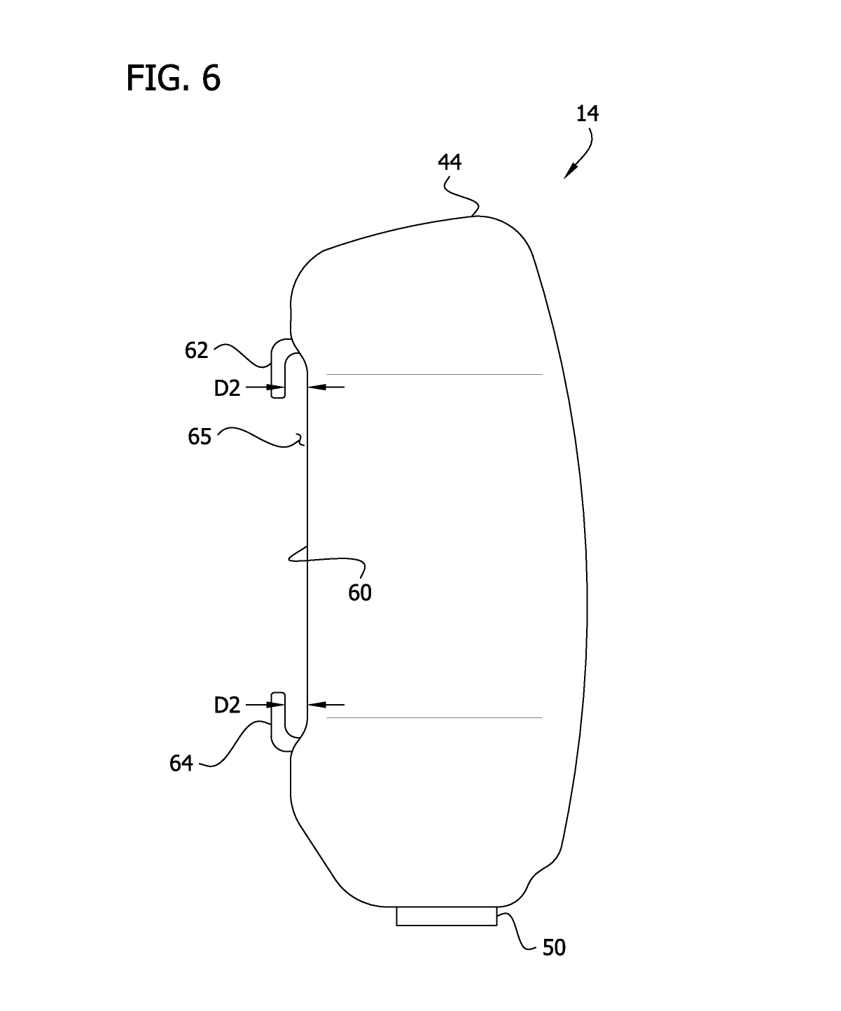

As shown in FIG. 5, the controller structure configured for cooperating with the strap 16 for mounting the controller 14 on the compression garment 12 includes a strap mounting surface 60 and first and second retainers 62, 64. Referring to FIG. 6, the strap mounting surface 60 and the retainers 62, 64 at least partially define an opening 65 in the controller 14 for receiving the intermediate strap segment 16G. The strap segment 16G is shown in the opening 65 in FIGS. 1 and 2.

The mounting surface 60 is adapted to engage the inner face 16E of the strap 16. As shown in FIG. 5, The mounting surface 60 has a centerline A2 separating a first boundary edge 66 and a second boundary edge 68. The first and second boundary edges 66, 68 are spaced for receiving therebetween the inner face 16E of the strap 16 in engagement with the mounting surface 60. In this position, the central longitudinal axis Al of the strap 16 extends generally parallel to the centerline A2 of the mounting surface 60 of the housing 44.

The retainers 62, 64 maintain the orientation of the controller 14 with respect to the strap 16 and assist in preventing the strap from being inadvertently removed from the opening 65. Referring again to FIG. 5, the first retainer 62 extends from the housing 44 on a first side of the mounting surface centerline A2 to a free end 62A positioned with respect to the mounting surface to overlap the first side 16C of the strap 16 when the inner face of the strap 16E engages the mounting surface and the central longitudinal axis A1 of the strap 16 extends generally parallel to the centerline A2 of the mounting surface. Moreover, the second retainer 64 extends from the housing 44 on a second side of the mounting surface centerline A2 opposite the first side of the mounting surface centerline to a free end 64A positioned with respect to the mounting surface 60 to overlap the second side 16D of the strap 16 when the inner face 16E of the strap engages the mounting surface and the central longitudinal axis A1 of the strap extends parallel to the centerline A2 of the mounting surface. Each of the first and second retainers 62, 64 has a base 62B, 64B adjacent a respective mounting surface boundary edge 66, 68. The free ends 62A, 64A of the first and second retainers 62, 64 are spaced from each other by a gap G1. The bases 62B, 64B are spaced from each other by a distance D1 generally corresponding to the width WI of the strap 16. As shown in FIG. 6, each of the free ends 62A, 64A of the first and second retainers 62, 64 is spaced from the mounting surface 60 by a distance D2 generally corresponding to (but preferably slightly greater than) the thickness T1 of the strap. In the illustrated embodiment, the first and second retainers 62, 64 project along a line A3 extending generally perpendicular to the mounting surface centerline A2. Moreover, in the illustrated embodiment, each of the first and second retainers 62, 64 has a width W2, W3 aligned generally parallel to the centerline A2 of the mounting surface 60 (FIG. 5). The widths W2, W3 may be larger than the distances D3, D4 by which the corresponding free ends 62A, 64A of the retainers 62, 64 overlap the corresponding sides 16C, 16D of the strap (FIG. 1). The strap 16 is shown against the strap mounting surface 60 in the opening 65 in FIG. 1, with the first and second retainers 62, 64 overlapping respective side portions of the strap.

In the illustrated embodiment, the retainers 62, 64 are shown as being unitary with the controller housing 44. Alternatively, the retainers 62, 64 may be formed separately from the housing 44 and attached to the housing. Desirably, the retainers 62, 64 are fixed against movement with respect to the housing 44, but in some embodiments (not shown) the retainers may be movable (e.g., pivotable) with respect to the housing to assist in placement of the strap against the mounting surface 60, in the opening 65. In embodiments in which the strap 16 is semi-extensible or extensible, the strap may be more easily moved into the opening 65 with or without the retainers being movable with respect to the housing 44.

Controllers having structure other than described herein for cooperating with the strap for mounting the controller on the compression garment may be used without departing from the scope of the present invention. For example, the mounting surface 60 and the retainers 62, 64 may have dimensions other than shown. Moreover, the mounting surface and retainers may have other configurations without departing from the scope of the present invention.

As is now apparent, the controller 14 may be mounted on the compression garment 12 by moving the controller into the space 40 between the inner face 16E of the strap 16 and the outer surface 28 of the compression garment 12. The intermediate segment 16G of the strap 16 is positioned between the retainers 62, 64 and inserted in the opening 65 in the controller 14 defined in part by the strap mounting surface 60 and the retainers 62, 64. The intermediate segment 16G may be moved into the opening by folding the segment to a size sufficiently small to fit through the gap G1 separating the free ends 62A, 64A of the retainers 62, 64. In this way the gap G1 is sized to receive the strap 16 when inserting the strap between the first and second retainers 62, 64. In this position, the inner face 16E of the strap 16 engages the strap mounting surface 60, and the retainers 62, 64 overlap respective side portions of the strap 16 to retain the strap in the opening 65. Alternatively, the strap 16 may be threaded through retainers 62, 64 and then attached to the garment 12. Other sequences for attaching the controller 14 using the strap 16 will be appreciated by those of ordinary skill in the art.

In a cycle of use, the compression garment 12 is applied to a body part, and the controller 14 is activated to apply compression therapy on the body part. The controller 14 may be mounted on the compression garment 12 before or after the compression garment is applied to the body part. Depending upon the configuration of the compression garment 12 and the programming of the controller 14, intermittent sequential compression therapy or other types of compression therapy may be applied. Upon completion of the compression therapy, the compression garment 12 may be discarded and the controller 14 can be mounted on a different compression garment.

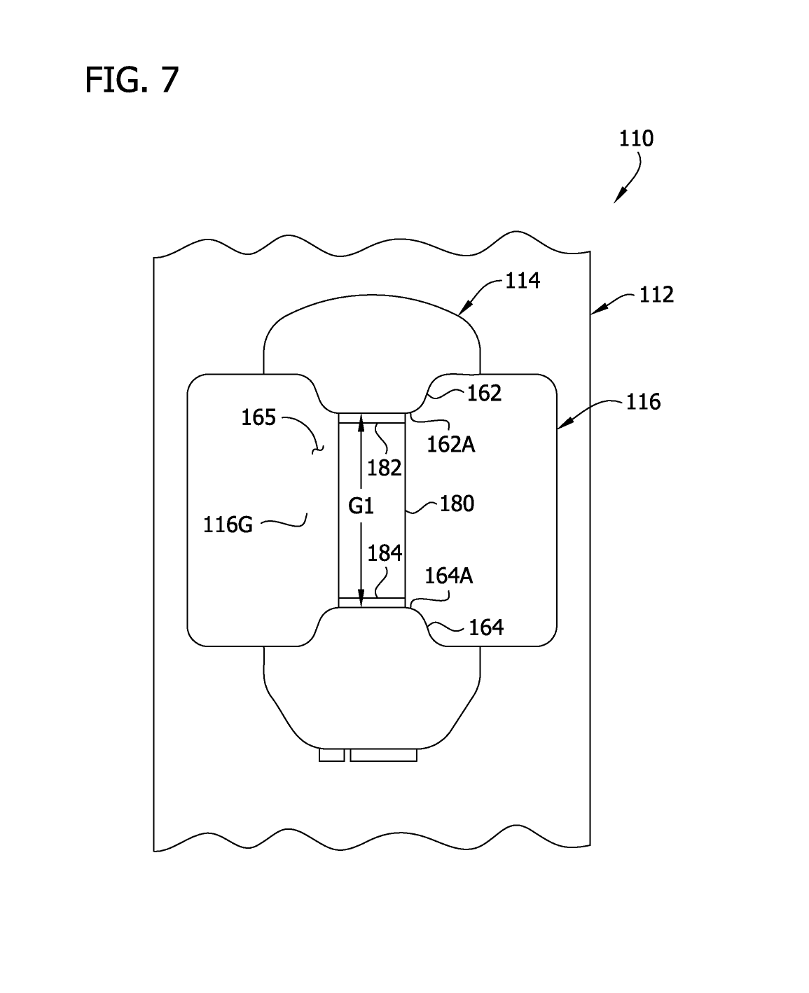

FIG. 7 illustrates an additional embodiment of a compression garment assembly of the present invention generally indicated by the number 110. The assembly is similar to the assembly 10 described above, and corresponding parts are indicated by corresponding reference numbers, plus 100. For example, the assembly 110 includes a compression garment 112 (only a portion being shown), a controller 114, and a strap 116. In this embodiment, the structure on the controller 114 configured for cooperating with the strap 116 for mounting the controller on the compression garment 112 further includes a bridge member 180. The bridge member 180 connects the free end 162A of the first retainer 162 to the free end 164A of the second retainer 164. The bridge member 180 assists in maintaining the intermediate strap segment 116G in the opening 165. In other words, the bridge member 180 assists in maintaining the controller 114 in its desired position mounted on the compression garment 112.

In the illustrated embodiment, the bridge member 180 is shown connected to the retainer free ends 162A, 164A by connecting members 182, 184. The connecting members 182, 184 may releasably connect the bridge member to the first and/or second retainers 162, 164 so that the bridge member may be selectively removed from the retainers. Thus, the bridge member 180 can be moved away from the gap GI between the free ends 162A, 164A of the retainers (e.g., by removing the bridge member from the controller 114 or pivoting it about one of the connection members 182, 184) to facilitate movement of the strap 16 into the opening 165. After the strap segment 116G is positioned in the opening 165, the bridge member 180 can be moved back to its position in which it connects the retainers 162, 164. In other embodiments, the bridge member is permanently attached or integrally formed.

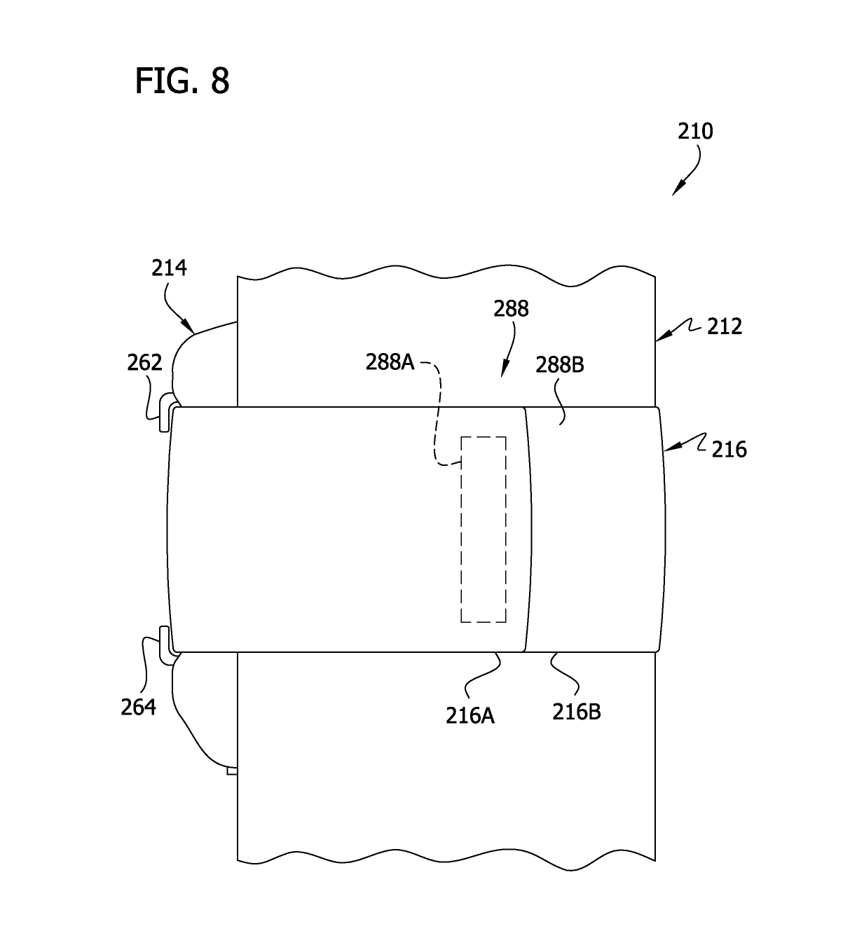

FIG. 8 illustrates an additional embodiment of a compression garment assembly of the present invention generally indicated by the number 210. The assembly is similar to the assembly 10 described above, and corresponding parts are indicated by corresponding reference numbers plus 200. For example, the assembly 210 includes a compression garment 212 (only a portion being shown), a controller 214, and a strap 216. The controller 214 includes retainers 262 and 264. In this embodiment, the strap 216 has a different configuration. More specifically, the strap 216 has a length extending between the first and second ends 216A, 216B sized so the strap can be wrapped around the compression garment 212 and around the limb to which the compression garment is applied. The first end 216A overlaps the second end 216B of the strap. The strap 216 includes a fastener 288 for securing the strap wrapped around the compression garment 212. For example, the fastener 288 may include a section of hook fabric 288A on an inside surface of the first end 216A of the strap 216 which fastens to loop material 288B provided on the outside surface of the second end 216B of the strap.

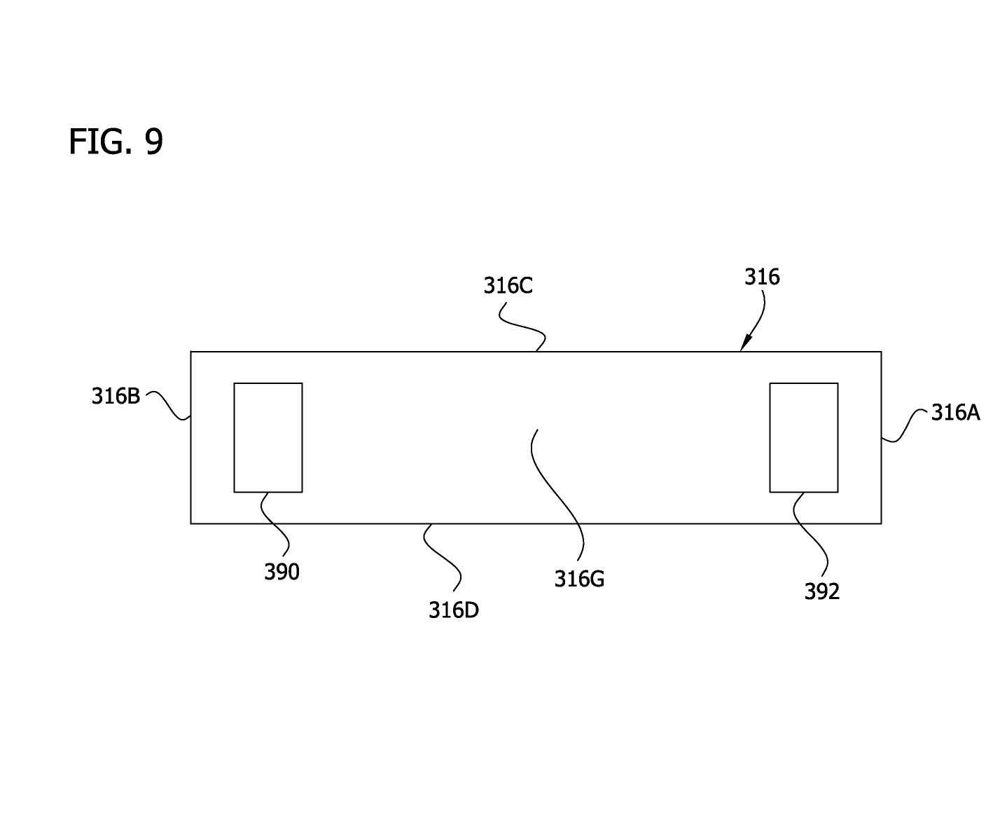

FIG. 9 illustrates a rear elevation of an additional embodiment of a strap of the present invention generally indicated by the number 316. The strap is similar to the strap 16 described above, and corresponding parts are indicated by corresponding reference numbers plus 300. For example, the strap 316 includes opposite ends 316A, 316B, opposite sides 316C, 316D extending between the ends, and an intermediate segment 316G between the ends. In this embodiment, the strap 316 includes fasteners 390, 392 for fastening the strap ends 316A, 316B to a compression garment such as the garment 12. For example, the fasteners 390, 392 may be sections of hook and/or loop fabric, adhesive, or other suitable fasteners such as buttons, snaps, latches, or buckles. The fasteners 390, 392 make the strap selectively mountable or releasably attachable on the compression garment. The strap 316 may be used with different compression garments. Moreover, the strap 316 may be attached to the compression garment in various positions on the compression garment. For example, the sections of hook fabric 390, 392 may be fastened to loop material at various positions on the outer surface of the compression garment. A controller such as the controller 14 may be mounted on the strap 316 before the strap is attached to the compression garment. Finally, the controller may be mounted on the strap 316 after one of the ends 316A, 316B of the strap is attached to the compression garment but before the other of the ends is attached to the compression garment. Thus, the free end of the strap 316 may be “threaded” through the opening in the controller before attaching the free end to the compression garment.

In other embodiments (not shown), the first end of the strap may be fixed to the compression garment and the second end may be selectively attachable to the garment (e.g., using a fastener). These and other configurations may be used without departing from the scope of the present invention.

When introducing elements of the present invention or the preferred embodiments(s) thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense,

What is claimed is:

1. A portable controller configured for use with a flexible elongate strap to releasably mount the controller on a compression garment for providing compression therapy to a body part of a wearer, the strap having opposite inner and outer faces extending longitudinally between a first end and a second end opposite said first end and laterally between a first side and a second side opposite said first side, the controller comprising:
a housing sized and shaped for holding components for controlling inflation and deflation of the compression garment, the housing including a strap mounting surface having a centerline separating a first boundary edge and a second boundary edge, said first and second boundary edges being spaced for receiving therebetween one of said inner and outer faces of the strap so a central longitudinal axis of the strap extends generally parallel to the centerline of the mounting surface of the housing;
a first retainer extending from the housing on a first side of the mounting surface centerline to a free end positioned with respect to the mounting surface to overlap the first side of the strap when the respective face of the strap engages the mounting surface and the central longitudinal axis of the strap extends generally parallel to the centerline of the mounting surface; and
a second retainer extending from the housing on a second side of the mounting surface centerline opposite said first side of the mounting surface centerline to a free end positioned with respect to the mounting surface to overlap the second side of the strap when the respective face of the strap engages the mounting surface and the central longitudinal axis of the strap extends generally parallel to the centerline of the mounting surface.

2. A portable controller as set forth in claim 1 wherein each of said first and second retainers has a base adjacent the respective mounting surface boundary edge, said bases being spaced from each other by a distance generally corresponding to a width of the strap.

3. A portable controller as set forth in claim 1 wherein each of the free ends of said first and second retainers is spaced from the mounting surface by a distance generally corresponding to a thickness of the strap.

4. A portable controller as set forth in claim 1 wherein said first and second retainers are aligned along a line extending generally perpendicular to the mounting surface centerline.

5. A portable controller as set forth in claim 1 wherein the free ends of said first and second retainers are spaced from each other by a gap sized to receive the strap when inserting the strap between the first and second retainers to engage the respective face of the strap with the mounting surface.

6. A portable controller as set forth in claim 1 wherein said first and second retainers are unitary with the housing.

7. A portable controller as set forth in claim 1 wherein said first and second retainers are fixed against movement with respect to the housing.

8. A portable controller as set forth in claim 1 wherein:
the mounting surface is adapted to engage the inner face of the strap; and
the housing is contoured to correspond to a preselected portion of the body part of the wearer.

9. A portable controller as set forth in claim 1 wherein each of said first and second retainers has a width aligned generally parallel to the centerline of the mounting surface of the housing, the widths being larger than a distance by which the corresponding free end of the respective retainer overlaps the corresponding side of the strap.

10. A portable controller as set forth in claim 1 further comprising said components for controlling inflation and deflation of the compression garment.

11. A portable controller as set forth in claim 10 in combination with the strap.

12. A portable controller as set forth in claim 11 in combination with the compression garment.

13. A portable controller as set forth in claim 12 wherein both ends of the strap are attached to the compression garment.

14. A portable controller as set forth in claim 11 wherein the first end and the second end of the strap are selectively attachable to the compression garment.

15. A portable controller as set forth in claim 11 wherein the strap is sized for wrapping around the compression garment and includes a fastener for securing the strap in a position in which it is wrapped around the compression garment.

16. A portable controller as set forth in claim 1 further comprising a bridge member connecting the free end of the first retainer to the free end of the second retainer.

17. The portable controller of claim 16 wherein the bridge is removable from at least one of the first and second free ends.

18. A method of mounting a portable controller housing on a compression garment using a strap, said method comprising:
positioning the controller between an outer surface of the compression garment and an inner face of the strap; and
inserting a segment of the strap in an opening of the controller housing so the inner face of the strap engages the housing.

19. A method as set forth in claim 18 wherein inserting a segment of the strap in the opening comprises positioning the segment of the strap between opposing retainers of the housing.

20. A method as set forth in claim 19 wherein positioning the segment of the strap between the opposing retainers of the housing includes folding the segment to a size sufficiently small to fit through a gap separating free ends of said retainers.
